(19) United States
(12) Patent Application Publication
(10) Pub. No.: US 2019/0080341 A1
(43) Pub. Date: Mar. 14, 2019

(54) Method and System for Computer-Assisted Paint Selection

(71) Applicant: Akzo Nobel Coatings International B.V., Arnhem (NL)

(72) Inventors: Darlene Eilenberger, Shelby Township, MI (US); Benjamin Beltser, West Bloomfield, MI (US); Reiko Toyo Kikuchi, Ferndale, MI (US)

(21) Appl. No.: 16/124,892

(22) Filed: Sep. 7, 2018

Related U.S. Application Data
(60) Provisional application No. 62/555,706, filed on Sep. 8, 2017.

(51) Int. Cl. G06Q 30/02; G06F 3/0481; G01J 3/52; G06F 3/0482; G06Q 40/08; G06Q 10/06

(52) U.S. Cl. CPC G06Q 30/0206; G06F 3/04817; G01J 3/52; G06Q 10/06398; G06Q 40/08; G06Q 10/06393; G06F 3/0482

(57) ABSTRACT

Disclosed is a database-based computing method and system that takes into account performance properties of various refinish paint products, helping to highlight and support the value that certain paint products bring to an automotive body or collision shop or the like.

### CROSS REFERENCE TO RELATED APPLICATIONS

A claim of priority for this application under 35 U.S.C. § 119(e) is hereby made to U.S. Provisional Patent Application No. 62/555,706, filed Sep. 8, 2017, which is hereby incorporated by reference in its entirety.

### TECHNICAL FIELD

Disclosed is a method and system for computer-assisted selection of paint products for use in the automotive refinish industry and other markets. In particular, disclosed is a database-based computing method and system that can help take into account strong performance properties of various paint products, helping to highlight and support the value that certain paint products bring to body or collision shop industry or the like.

### BRIEF DESCRIPTION OF THE DRAWINGS

FIG. 1 depicts a graphical user interface image comparing paint products (Exhibit A)

FIG. 2 depicts a graphical user interface comparing process time and cost information between paint brands (Exhibit B).

FIG. 3 depicts a graphical user interface where key performance indicators for a body shop business are entered (Exhibit C)

FIG. 4 depicts a graphical user interface where a comparison summary of projected total costs per job are shown (Exhibit D).

FIG. 5 depicts a graphical user interface where a final analysis of the brand comparison is shown (Exhibit E)

### DETAILED DESCRIPTION

The method and system described herein is configured to evaluate and compare the performance properties of automotive refinish paints in an applicable market, by reference to data regarding refinish products that are available to the automotive refinish industry, such as from national suppliers.

The method and system compares product performance and application parameters as specified by technical specification criteria established by automotive paint manufacturers and calculates the impact on collision shop for process throughput time, automotive paint cost and overall financial profitability. Criteria used to calculate over-all performance results is pre-determined by benchmarking current operation performance results and computing potential effect on overall business outcome if a change in manufacturer system was considered.

The method and system incorporates a comprehensive database that houses automotive paint products with performance parameters as specified by manufacturers. When a user accesses the system, the user through a series of dropdown features identifies a current automotive paint system that a collision shop is set to use, and the user identifies a proposed paint system for consideration. Once paint products are selected, the system generates and presents to the user a detailed analysis and summation and comparison of process time by individual products and total system, and the system generates and displays/summarizes the product cost per product and system based on manufacturer-suggested pricing.

The next step in the process is to identify and obtain the collision shops benchmark criteria such as existing process time, annual number of repairs, revenue, equipment performance, paint costs, profitability, insurance allowances, etc. to be input into the system. After obtaining all of the required customer information the system will calculate the theoretical results that can be obtained by the conversion to a different automotive paint system.

The system then displays calculation results in a comprehensive report both numerically and graphically displaying the comparison of paint systems and business performance and could provide a PDF summary report or the like.

Underlying the method and system is a refinish product database that includes information about performance and cost of various refinish paint products of various manufacturers and that links each product to a respective manufacturer and categorizes products by type to help facilitate comparison of similar types of products as between manufacturers. This performance and cost information can be ascertained from manufacturer technical specifications and the like and stored in a database (e.g., a relational database) that will then be a core reference in operation of the method and system.

In an example implementation, the database contains a list of automotive refinish paint products with performance properties that include sprayable cost, coats to hide, flash time properties, bake properties, total process time and mix ratios. These and/or other product characteristics and properties are derived from technical datasheets created and published from the paint manufacturers and stored in the database.

Further, the database would optimally be structured to link products to manufacturers so as to allow for proper comparisons from one manufacturer's products to another manufacturer's products. In addition, the database would link products by category to help ensure that the method and system compares competitive products, i.e., comparable products of the same type. Furthermore, the database would link products with manufacturer brands, to help ensure that manufacturers, brands, and products are aligned.

Additionally underlying the method and system are program instructions executable by a processing unit (e.g., a microprocessor) to carry out the process of comparing various refinish paint products and providing useful output, to help facilitate user selection of refinish paint products that would be most commercially valuable in terms of overall processing and profit.

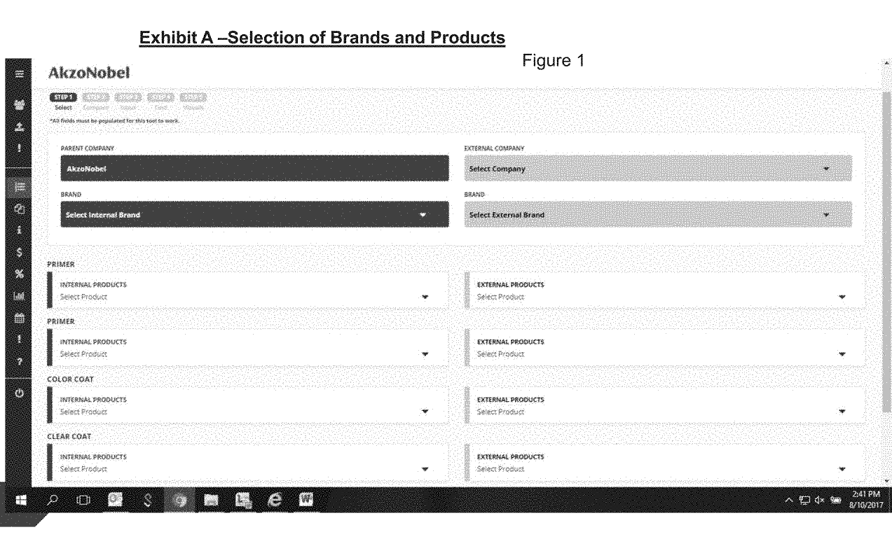

In accordance with the process, the method and system initially presents a graphical user interface including various drop-downs through which the user can select manufacturers whose products are to be compared, brands of the manufacturers to be compared, and specific individual products by category of the manufacture brands to be compared. This graphical user interface is shown by way of example in FIG. 1 (also shown as Exhibit A). Here, the drop-downs are sourced to respective information of the underlying refinish paint product database.

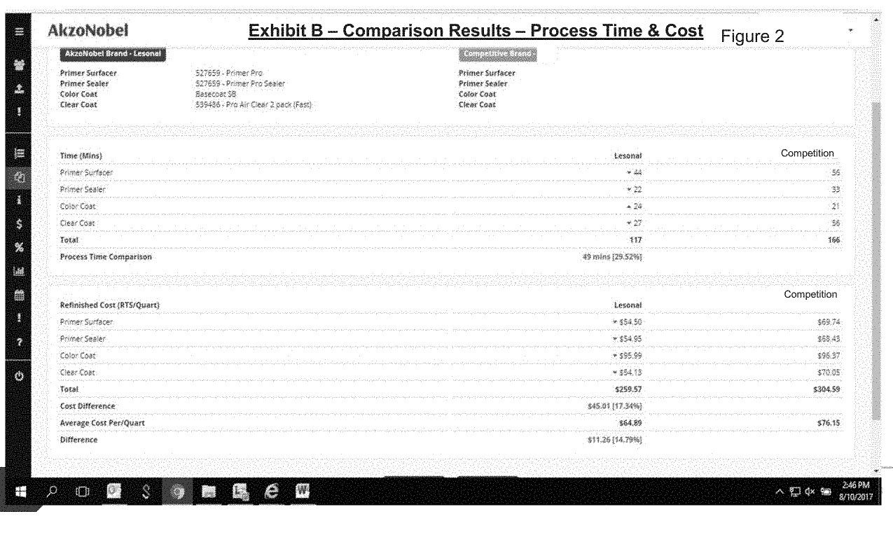

After receiving the user selection of the brands to be compared, the method and system then presents the user with a further graphical user interface that shows a comparison of process time and cost information as between the brands being compared (again, sourced to the underlying refinish paint product database), and that shows percent difference in processing time as between the brands, as well as percent difference in cost (e.g., per volume unit such as 1 liter can) as between the brands—which the method and system determines by comparing the indicated data. FIG. 2 (also shown as Exhibit B) shows this by way of example, where a first manufacturer's brand of products (e.g., primer surfacer, primer sealer, color coat, and clear coat) is shown with a 29.52% time savings and a 14.79% cost savings as compared with a second manufacturer's brand of similar products.

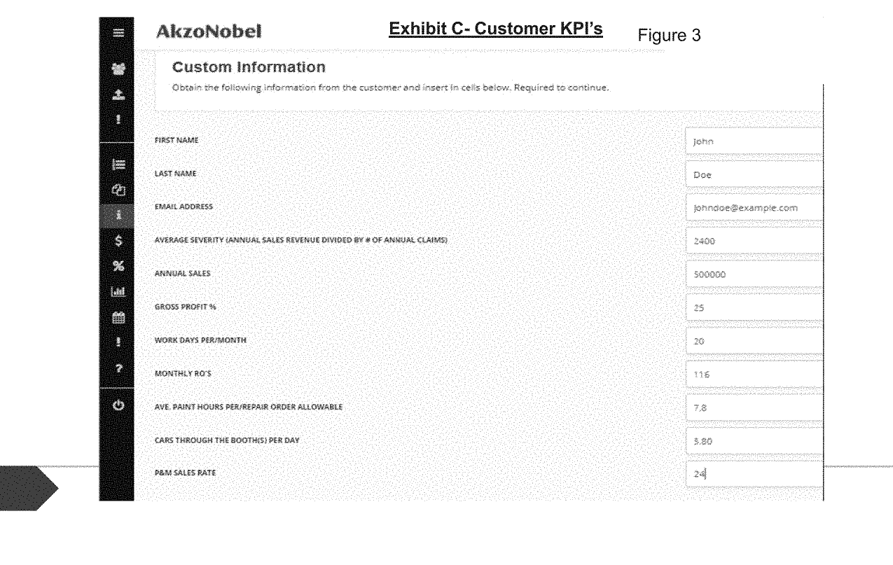

In addition, possibly after presenting this summary time and cost comparison of the brands, the method and system presents the user with a graphical user interface through which the user can enter certain key performance indicators (KPIs) regarding the user's refinish paint business, e.g., body shop business. FIG. 3 (also shown as Exhibit C) is an illustration of this. As shown, these KPIs could include information such as average severity, annual sales, gross profit, days worked per month, number of monthly repair orders, paint hours per repair orders, daily cars through a booth, and insurance allocations and material sales rate.

The method and system could then use these KPIs, along with the time and cost comparison data earlier established, and other information such as insurance allocations, as a basis to calculate and project theoretical difference in business results (e.g., vehicle throughput, cost, profit, etc.) as between the brands being compared.

In practice, for instance, the method and system could programmatically evaluate how the difference in process time could result in (i) a difference in number of vehicles processed by the user's body shop, (ii) a difference in monthly repair orders, (iii) a difference in total sales (for average severity repair jobs) per month, and (iv) a difference in total gross profit per month.

### EXAMPLES

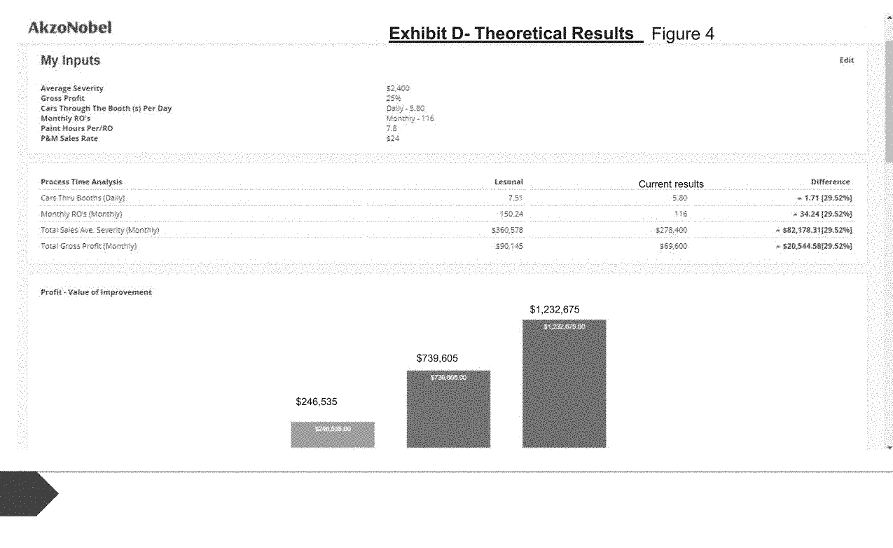

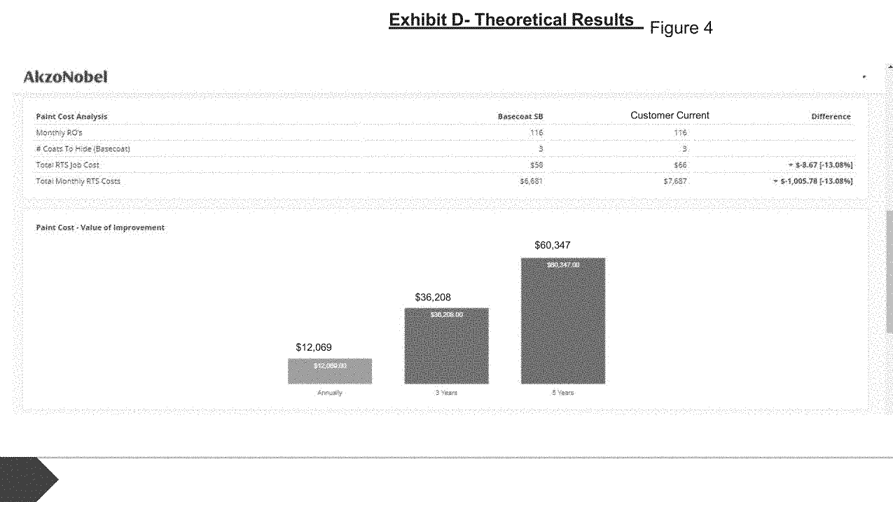

By way of example, with a 29.52% difference in processing time as between the brands being compared, and given the user-provided KPIs and insurance allocations and the like, the method and system might compute that one brand could result in an average of 1.71 more vehicles being processed per day, 34.24 more repair orders being processed per month, $82,178 more sales per month, and $20,544 more profit per month. And as another example, with a 14.79% difference in average product cost as between the brands being compared, and given the user-provided KPIs and insurance allocations and the like, the method and system might compute that one brand could result in $8.67 cost savings based on a pre-determined standardized repair and perhaps a $1,005 cost savings per month. Further, the method and system could more specifically compute savings for paint and material costs by using one brand versus another, considering insurance allocations per repair and considering the user-provided KPIs, and the method and system could present a comparison of summary projected total cost per job, which could show that one brand is less costly per job than the other brand. FIG. 4 (also shown as Exhibit D) shows representative output that the method and system could provide at this stage.

Thus, by way of example, the method and system could evaluate processing time as follows:
The speed of a system can affect the number of cars that can be repaired daily. Therefore, the percent difference can be directly applied to the current number of repairs daily and provide a theoretical number of cars through the booth/shop.
The processing time impacts the amount of revenue & profitability that could result based on more cars repaired. Improvement can be calculated based on current customer revenue and profitability results.
The processing time impacts the number of repair orders through the shop, which in turn affects the total revenue and gross profit. Repair order increased can be calculated based on improved process time and in turn used to calculate improved revenue.
The processing time impacts the amount of paint required to perform the job. The more repairs the more paint, which in turn affects the paint and material costs.
More repair orders correlate to more paid paint and material hours from insurance company.
The more paint required to meet coverage or hiding properties impacts cost.
   Further, the method and system could evaluate product cost, considering the following:

Paints typically require three components to achieve sprayability of product. The components when mixed determine the sprayable costs of a repair.
Component A=product to be applied
Component B=Activator to induce dry properties
Component C=Thinner or reducer used to allow the product to flow through a piece of spray equipment for application on the vehicle.
The ready-to-spray costs determine the total paint cost of the repair. Reduction in sprayable costs will improve collision shop profitability.
Insurance company provides a pre-determined rate per/hour for paint and materials. The lower the paint sprayable cost the more profit for the collision shop.
The more paint required to meet coverage or hiding properties increases the cost of the repair and in turn the profitability of the collision shop. Coats to hide properties are important to the performance results and also the profitability.

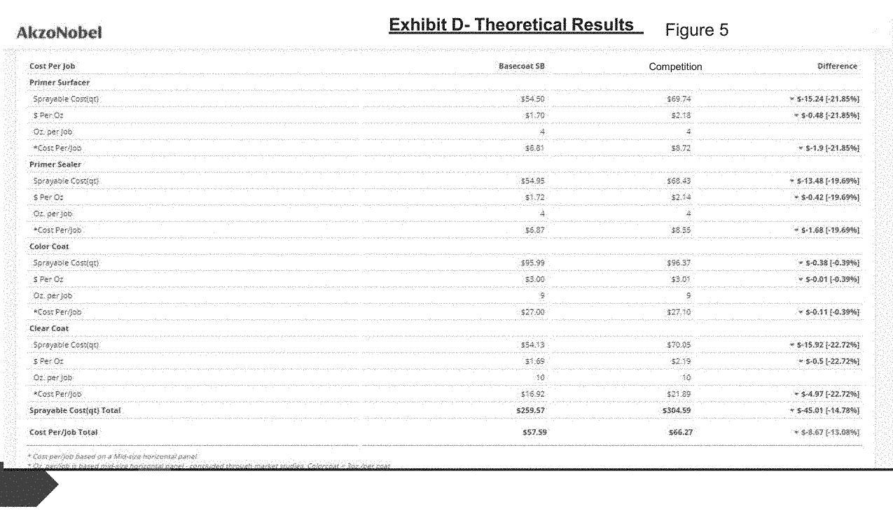

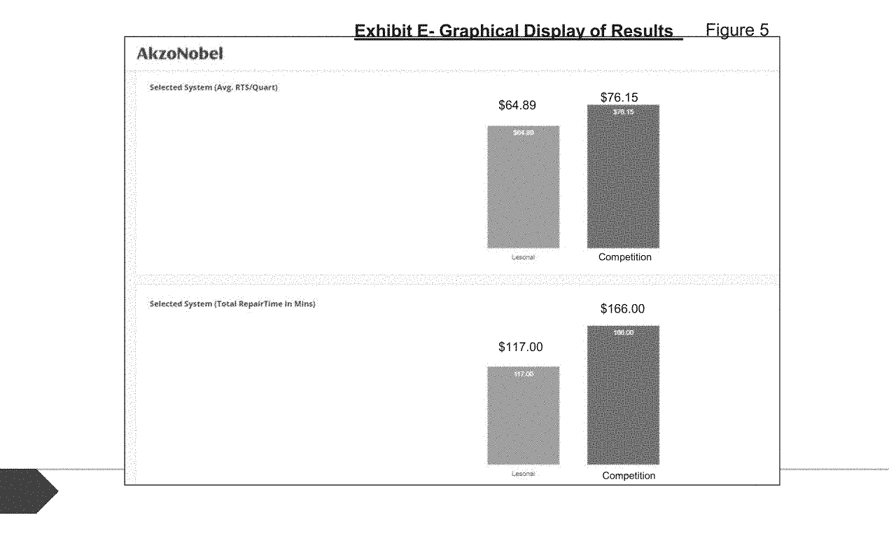

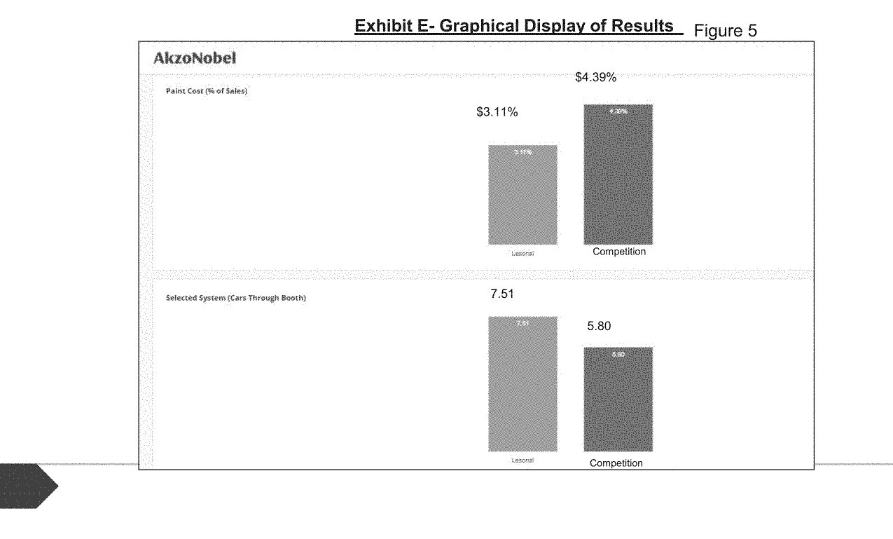

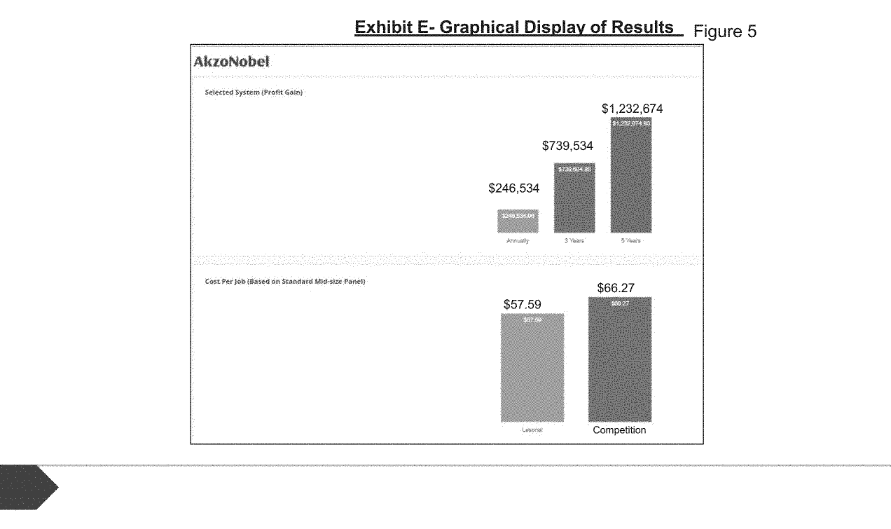

Once the method and system has completed its analysis, the method and system then presents a graphical user interface including a number of graphs that illustrate the results of the analysis. FIG. 5 (shown as Exhibit E) is an example of this, where bar charts show the determined results as between the brands being compared, such as:
Profit Potential-due to increase thru-out as a result of improved process time
Paint costs compared to existing system
Paint system selection (primers, clears, color) ready to spray costs
Total repair time for selected system (primers, clears, color)
Paint cost as a % of sales
Cars through the booth
Total profit based on process time, ready-to-spray cost

Further, the method and system could then generate and e-mail a PDF document that illustrates in summary the user-input and other data received and the results of its analysis.

The foregoing detailed description, examples, and accompanying figures have been provided by way of explanation and illustration, and are not intended to limit the scope of the invention. Many variations in the present embodiments illustrated herein will be apparent to one of ordinary skill in the art, and remain within the scope of the invention and their equivalents. The skilled person in the art will recognize many variations that are within the spirit of the invention and scope of any current or future claims.

That which is claimed is:

1. A method for selection of paint products for use in the automotive refinish industry, wherein the method comprises
(a) a user accessing a database that contains automotive refinish paint products with performance parameters specified by manufacturers; and
(b) evaluating and comparing the performance parameters of automotive refinish paint in an applicable market
(c) wherein the method is executable by a processing unit.

2. The method of claim 1, wherein the user accesses the database through a graphic user interface, wherein such graphic user interface has a series of dropdown features that identifies the current paint products that a collision or body shop is set to use, and then the user identifies a proposed paint system for consideration.

3. The method of claim 2, wherein after the proposed paint system is selected by the user, the system generates and presents to the user a detailed analysis and summation comparison of the process time by individual products and total cost, and the system generates and displays the product cost per product and system based on manufacturer suggested pricing.

4. The method of claim 3, wherein the user inputs collision shops benchmark criteria, to obtain the detailed result for converting to a different automotive paint system.

5. The method of claim 1, wherein the performance parameters comprise sprayable cost, coats to hide, flash time properties, bake properties, total process time, mix ratios and other product characteristics derived from technical data sheets or from paint manufacturers.

6. The method of claim 1, wherein the database is structured to link products to manufacturers or products to categories to facilitate comparisons.

7. The method of claim 3, wherein the user can enter key performance indicators regarding the user's vehicle refinish business, wherein such key performance indicators comprise average severity, annual sales, gross profit, days worked per month, number of monthly repair orders, paint hours per repair orders, daily number of cars thru a booth, insurance allocation and material sales rate.

8. The method of claim 7, wherein the KPI's and the process time and cost comparisons, and insurance allocations, are collectively combined to project theoretical difference in business results as between brands being compared.
